(19) United States
(12) Patent Application Publication
(10) Pub. No.: US 2016/0098936 A1
(43) Pub. Date: Apr. 7, 2016

(54) Educational system for teaching science, history and other subjects

(71) Applicant: Peter R. SOLOMON, West Hartford, CT (US)

(72) Inventor: Peter R. SOLOMON, West Hartford, CT (US)

(21) Appl. No.: 14/756,737

(22) Filed: Oct. 7, 2015

Related U.S. Application Data
(60) Provisional application No. 62/071,971, filed on Oct. 7, 2014.
(60) Provisional application No. 62/179,677, filed on May 18, 2015.

(51) Int. Cl. G09B 5/06; G09B 19/00

(52) U.S. Cl. CPC G09B 5/065; G09B 19/0046

(57) ABSTRACT

A two-part educational system uses a virtual reality environment created on an internet connected computer or mobile device, populated with historical characters who are Expert Avatars, and which can be entered by students as avatars; and e-books or print books in which a fictional virtual reality environment is a central feature. Readers can visit a computer-based virtual reality environment, which reproduces the visits made by the book characters, to expand their knowledge through interactions with the activities and the Expert Avatars found there. Readers can also play a game in the computer-based virtual reality environment in which the Expert Avatar can provide information to make strategic game choices.

### BACKGROUND OF THE INVENTION

A need exists for an effective and engaging educational system for teaching science, history, and other subjects to pupils in kindergarten through high school grades, and beyond. Because of the shortage of certified science teachers in elementary and middle school, it is also desirable to have a system which can be used effectively with little or no teacher involvement. The object of the present invention is to provide such an educational system.

### BRIEF SUMMARY OF THE INVENTION

The system of the invention comprises two parts. The first part is a virtual reality environment provided with software on a computer or mobile device where students can enter, as a student avatar, any place at any time and at any size to pursue a number of activities and talk to, or ask questions of, a typical citizen or an historical figure or contemporary figure, called an Expert Avatar. To provide sufficient access to a large data base and system software, the computer or mobile device is typically connected to the internet or large server computer. The Expert Avatar is an important figure in the subject that is being taught to the student and can respond to the student's questions on the subject. The Expert Avatar employs a cognitive computer or artificial intelligence software such as IBM's Watson providing answers from a database for the Expert Avatar. Additionally, the virtual reality environment can host serious games intended to teach a subject in science, history or other fields. As part of the game, the student avatar can ask the Expert Avatar questions that can help the player in making strategic game choices The second part of the invention is a book series, either in the form of e-books or print books, the characters of which use a fictional virtual reality environment in which they can ask questions of fictional Expert Avatars as a central part of the story. The readers can then expand their knowledge by visiting, themselves, the same virtual reality places and Expert Avatars visited by the characters, or they can make other visits to satisfy their curiosity. For playing the game, the book acts as a stimulus, an introduction, a user guide and scaffolding should the student need help with making progress in the game. The book is an alternative way to learn the subject and can provide reinforcement to the lessons learned in the computer-based virtual reality environment and vice versa. The computer-based virtual reality environment can be used with a book and/or with classroom curricula or homework assignments (referred to comprehensively hereinafter as “books”). The Expert Avatars could be used for additional purposes, as well, such as to provide medical or travel advice. Because the Expert Avatar is providing information on a restricted body of knowledge, answers provided by the Expert Avatar can be more accurate than answers delivered by digital personal assistants such as Apple's Siri, Microsoft's Cortana, or Google's Now, which must provide answers on any subject.

More Specifically, the objects of the invention are attained by the provision of a system including a book in print or electronic form and a complementary computer-based virtual reality environment for use by the reader, implementing various activities to support games, virtual time and space travel and conversations with experts in each field of study represented as Expert Avatars included in the virtual reality environment. In the book the fictional characters are exposed to factual science, history or other subjects by using a fictional virtual reality environment to visit important people (Expert Avatars), places and events associated with these topics at any period in history. The visits to Expert Avatars may involve a conversation in which the characters ask questions of the Expert Avatars and receive factual answers.

The computer-based virtual reality environment to be visited by the reader of the book, which provides visual and auditory output, complements the fictional virtual reality environment of the book by providing representations of the same people, places and events presented in the book. It allows the reader to choose and affect the activities created by the virtual reality environment software. The functions of the virtual reality environment are created by electronic data processing hardware employing a combination of software components to create the visual and auditory components of the virtual reality environment. Such software can have multiple components residing on separate but digitally connected electronic data processing hardware to support the functions of visual display, avatar visualization and motion, game activities, user specific logs of activities, voice recognition, artificial intelligence, data bases, and speech synthesis. The artificial intelligence software has access to data bases specific to each Expert Avatar and general encyclopedia data bases to support a conversation between the reader and the Expert Avatar, whereby answers to questions asked by the reader using text or speech are provided in text form to be delivered verbally by the Expert Avatar using the speech synthesis software. In certain embodiments, the artificial intelligence software may be a hybrid system of software designed for conversations operating with a specific data base unique to the Expert Avatar plus a general search routine operating on a general encyclopedia data base, The digital connections of the data processing hardware can be made through Wi-Fi, wire, the internet, an intranet or other common connection means, The virtual reality environment is made available on a digital device such as a computer, smartphone, tablet, television or video game hardware which has speakers or headphones to provide sound output, a keyboard for typing user input, a microphone to collect auditory user input, a display screen to provide visual output and a mouse or touch screen to allow further input by the user. Preferably, the system allows the user to appear in the computer-based virtual reality environment as an avatar and is constructed to be employed by a single user or multiple users simultaneously.

The invention provides a method for learning about science, history and other subjects comprising reading a book, and using a complementary computer-based virtual reality environment, both as described above and below. The book provides an introduction and user's guide to the activities of the computer-based virtual reality environment which allows the reader to duplicate and expand the activities of the characters in the book. The computer-based virtual reality environment allows the reader to choose and affect the activities of the virtual reality and allows the reader to have a conversation in which he or she can ask questions of the important people, represented as Expert Avatars, and receive factual answers delivered by the Expert Avatar. The results of a student's activities may be recorded and stored for future use in a log book unique to each student, supported by the software.

### BRIEF DESCRIPTION OF THE SEVERAL VIEWS OF THE DRAWINGS

FIG. 1 is an illustration of a book character who is a student avatar visiting the town of Pisa, in Italy, taking to Galileo, who is the Expert Avatar, about his gravity experiments.

FIG. 2 is an illustration of a character in a story that uses a fictional virtual reality environment to visit his blood stream, to learn about cells and antibodies that attack him.

FIG. 3 is an illustration of what the book characters observe going back in time 4.5 billion years to witness the formation of the earth.

FIG. 4 is an illustration of Henrietta Leavitt in the Harvard Observatory, who is visited by characters in a book and who is an Expert Avatar in the computer-based virtual reality environment.

FIG. 5 is a plot showing the variation of brightness of a star over time that Henrietta Leavitt uses to explain her discovery.

FIG. 6. is an illustration of the a student asking questions of the Expert Avatar, Albert Einstein.

FIG. 7 is an illustration of one stage of an Evolution Game played in a computer-based virtual reality environment.

FIG. 8 is an illustration of several stages of the Student Avatars' creature in the Evolution Game.

FIG. 9 is an illustration of the book and computer-based virtual reality environment system for the teaching of the science, history or other subjects.

FIG. 10 is an illustration of a simple implementation of the Expert Avatar for Charles Darwin, that appears on a web site.

FIG. 11 is an illustration of a scene from The Stardust Mystery Game showing a Student Avatar outside the castle which is the main setting for the game activities.

FIG. 12 Shows a view from inside the castle in the library where the Student Avatar's Log Book is kept. The log book stores all of the Student Avatar's observations and answers to questions for each individual student as they play the game.

FIG. 13 is an image from The Stardust Mystery Game showing the Student Avatar in the Hall of Experts, where she can choose an Expert Avatar to visit and answer her questions.

FIG. 14 is an illustration of the screen from The Stardust Mystery Game showing the inside of the time machine during the current time, prior to time travel back in time. On a computer screen is the Expert Avatar who has been summoned to answer the student avatar's questions about the Big Bang.

FIG. 15 is an illustration of the screen from The Stardust Mystery Game showing the inside of the time machine during a transition from 65 million years ago to 270 million years ago. Outside the window is a view of the earth enveloped in dust from an asteroid impact that wiped out the dinosaurs. On the computer screen is a view of the continental drift occurring during the transition in time.

FIG. 16 is a diagram showing how two different artificial intelligence systems could be combined to provide answers from a specific data base created for each Expert Avatar, plus a general encyclopedia data base.

FIG. 17 is a diagram showing how two different artificial intelligence systems could be combined to provide answers from a general encyclopedia data base with confidence values, plus a “chat layer” application that manages the responses.

### DETAILED DESCRIPTION OF THE INVENTION

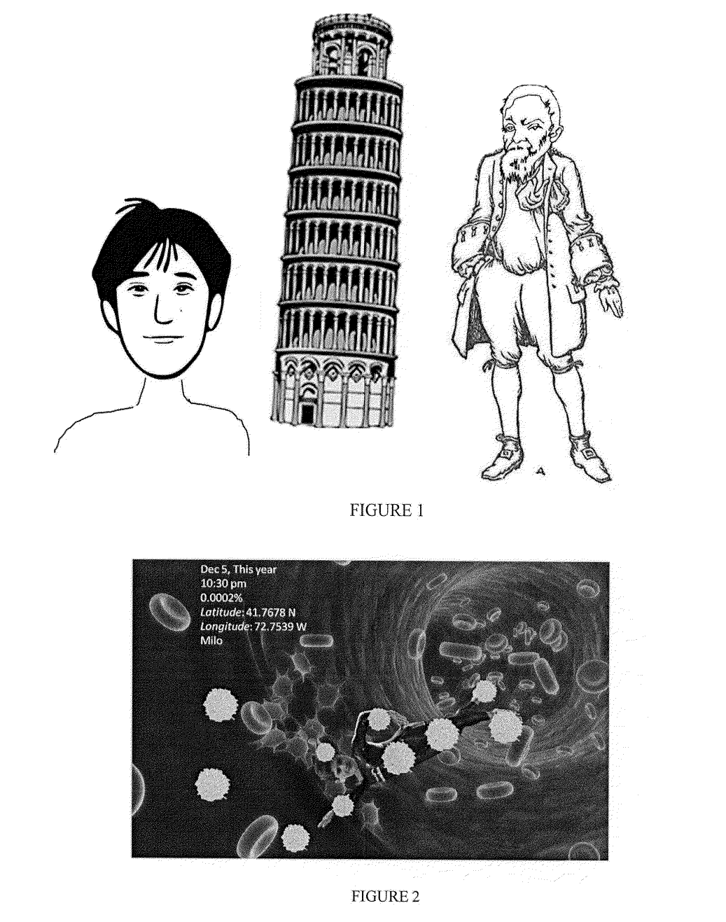

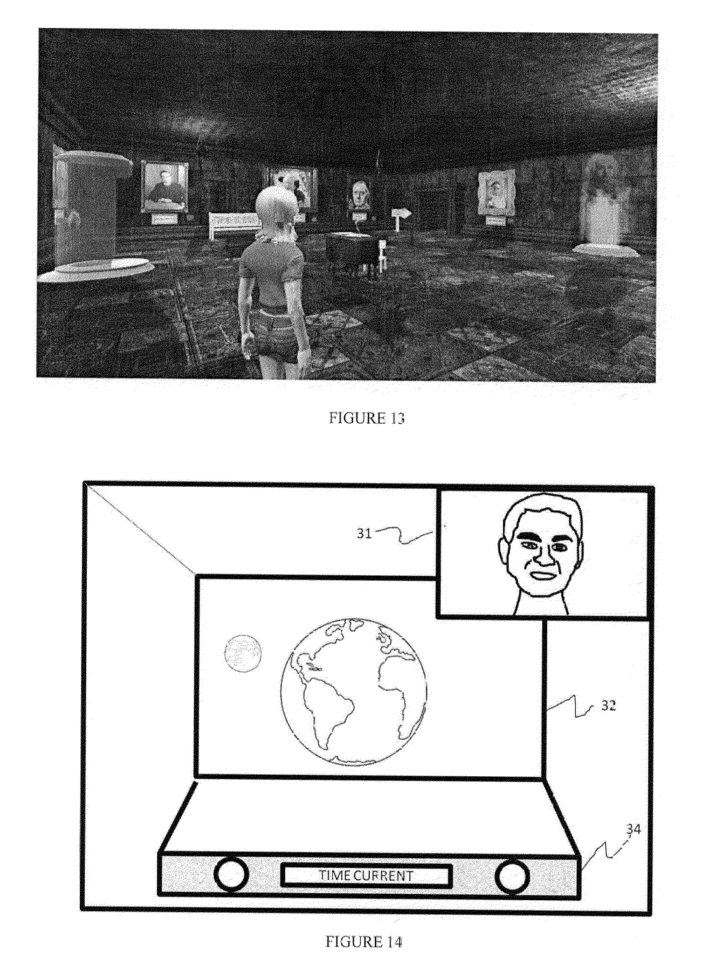

The virtual reality environment employed in the system of the invention and provided using a combination of software components on an internet (or local computer server) connected computer or mobile device. Thus, 3D virtual reality software such as Unity 3-D, game technology, plus geographical data and historical pictures, such as from Google, are employed to put avatars in the selected place and time. Examples are presented in FIGS. 1 to 4, 6, 7, and 10 through 15.

FIG. 14 is an illustration of the screen from The Stardust Mystery Game showing the inside of the time machine during the current time, prior to time travel back in time. On a computer screen 31 is the Expert Avatar who has been summoned to answer the Student Avatar's questions about the Big Bang. Out the window 32, is a view of the earth and moon as they appear today. At the bottom of the screen are the time controls 34, showing the current time.

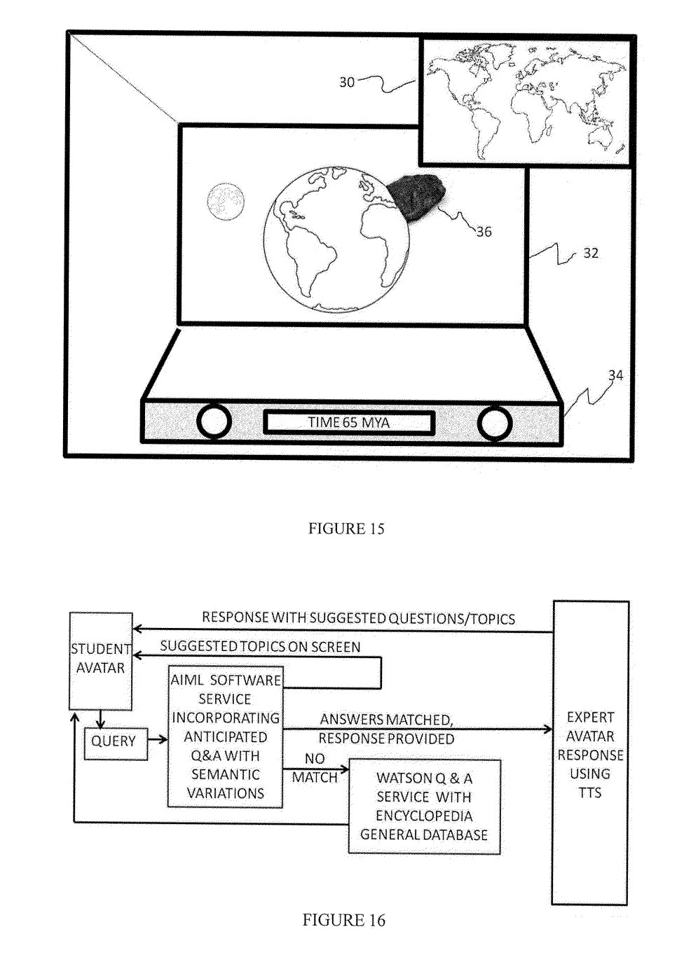

FIG. 15 is an illustration of the screen from The Stardust Mystery Game showing the inside of the time machine during a transition from 65 million years ago to 270 million years ago. Outside the window 32 is a view of the earth enveloped in dust from an asteroid 36 impact that wiped out the dinosaurs. On the computer screen 30 is a view of the continental drift occurring during the transition in time. The time controls 34 show the time as 65 MYA (million years ago).

Artificial intelligence and speech-recognition technology, such as Apple's “Siri,” Wolfram's “Alpha,” Pandorabots, and IBM's “Watson,” is used to recognize the student avatar's speech and to provide answers to questions based on the historical and scientific record for the Expert Avatar. A corpus of anticipated questions and scripted answers plus general encyclopedia information is created for each Expert Avatar which is used by the artificial intelligence software to provide the answer for the Expert Avatar to deliver using generally available text-to-speech (TTS) software.

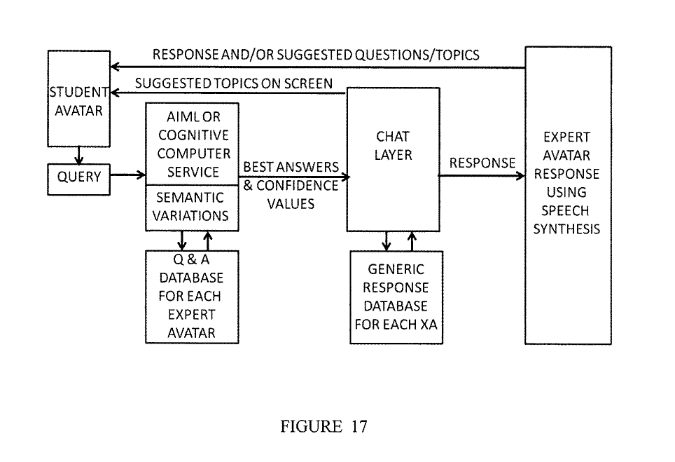

FIG. 16 illustrates how two artificial intelligence software systems could be combined. Queries could first be submitted to an Artificial Intelligence Markup Language (AIML) software system using the anticipated question data base (corpus). When no answer is found, the query can be submitted to a second artificial intelligence system like IBM's Watson using a general data base. Alternatively, answers can be provided from software like Watson with confidence levels indicating the degree of match between the question and the answer. An additional software application ‘Chat’ layer may be provided to deliver answers based on the confidence level. This hybrid system is illustrated in FIG. 17. For example, answers with sufficiently high confidence levels will be spoken by the Expert Avatar. Sufficiently low confidence levels will result in a generic statement, e.g. “can you rephrase the question” or “I don't know the answer.” With an ambiguous result, the Expert Avatar may offer “did you mean A or B?” Because the subject of questions for an Expert Avatar are generally confined to the body of knowledge on which he or she is an expert, the accuracy of responses is expected to be better than that for general digital personal assistants such as Apple's Siri, Microsoft's Cortana, or Google's Now. Accuracy of the answers from such digital personal assistants could be improved by asking to be provided with an Expert Avatar on the particular subject.

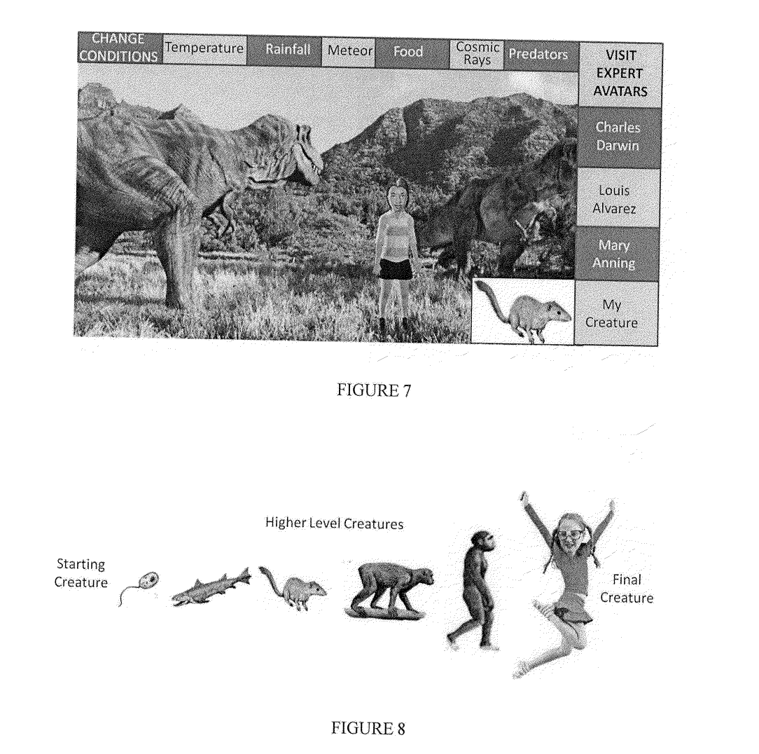

THE STARDUST MYSTERY and THE EVOLUTION GAME are representatives of a print book suitable for use in the present system. Four main characters of the books use the fictional virtual reality environment to solve a mystery or perform a science related task, in the course of which science is taught and learned. Once the actual virtual environment is created, the readers can log on and ask their own questions of the Expert Avatars as illustrated in FIG. 1, 4, 6, or 10, or visit places such as the early universe as illustrated in FIG. 3, 7, or 15, the blood stream as illustrated in FIG. 2 or play a game as illustrated in FIGS. 7, 8, and 11-15.

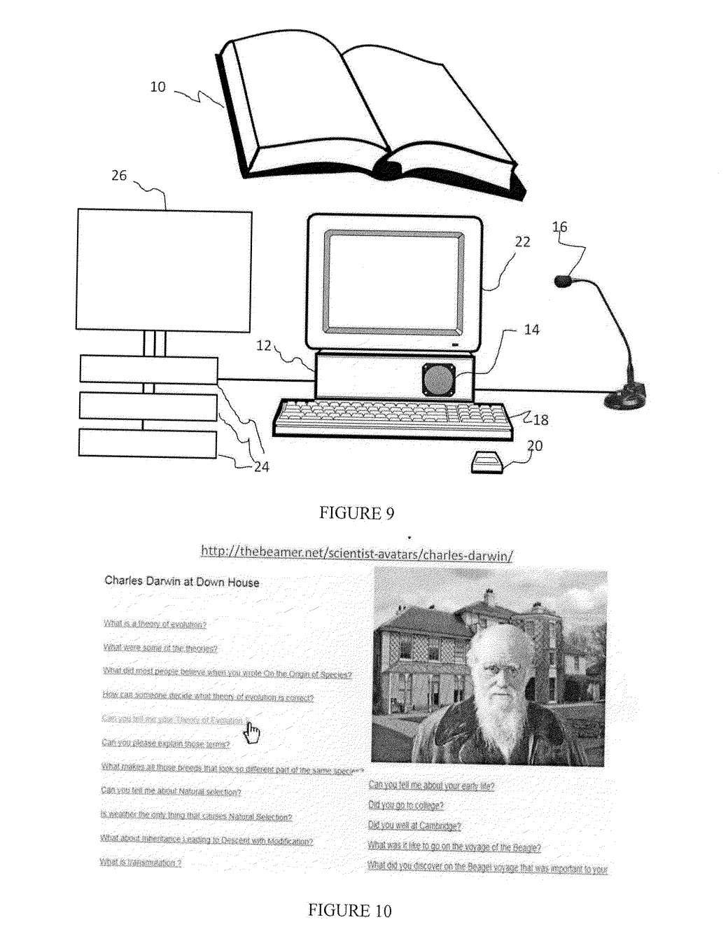

The combination of book and virtual reality activities for the teaching of the science, history or other subjects of evolution is illustrated in FIG. 9. As shown in FIG. 9, the system consists of a print book 10 and the computer-based virtual reality environment created with local computer 12 having a speaker 14, microphone 16, keyboard 18, mouse 20, and display 22. Operatively connected to the computer are external electronic data processing hardware 24 which may be in various remote locations, and multiple software 26 components operating on the computer and processing hardware.

To further explain the concept of the invention, a synopsis of THE STARDUST MYSTERY follows:

The story is about four cousins (one boy named Milo, and three girls named Lizzy, VC, and Neddy) who enter a contest, the grand prize in which is a trip around the moon. One motivation for entering the contest is to win the trip for the cousins' grandfather, who will be their coach and who failed in his own efforts to become an astronaut; the kids believe that he still has a dream to go into space.

The cousins succeed in winning a Regional competition by submitting an invention idea for a virtual reality environment (introduced later in the book) called the “Beamer,” in which the kids' avatars can visit a place at a time (present or past) and talk to then-contemporary historical figures. To describe the technology they show a visit to Pisa, Italy, in the year 1600, where they talk to Galileo (see FIG. 1) about his gravity experiments. The virtual reality website first uses speech recognition to convert the verbal questions to text. Galileo responds using Watson-like (IBM) technology based on the historical and scientific facts. The scene in the virtual reality is based on satellite images and historical photos.

Solving THE STARDUST MYSTERY is what the kids have to do for the finals, competing against six other teams. It is a puzzle: The premise is that the cousins are made of STARDUST that was once in the body of George Washington. What is STARDUST? Where did it come from? When and how was it formed? How did it get into George Washington's body? How did it get from his body to theirs? These are the things the contestants must figure out. It is all based on scientific fact.

In the story, the company that is running the contest has created the “Beamer” for the contestants to use in the finals. To solve the puzzle, the cousins use the “Beamer” to visit: George Washington crossing the Delaware River; Milo's bloodstream (see FIG. 2) where he is attacked by Killer T-cells; Lizzy's dog's hair, where she is threatened by a flea, the Big Bang, 13.8 billion years ago; the formation of Earth 4.5 billion years ago, during a period of continental drift (see FIG. 15), and first supernovae, nine billion years ago. They also visit and talk to important scientists to solve the puzzle: Johannes Kepler, Albert Einstein, George Lemaitre (theorist of the Big Bang), Edwin Hubble (where Lizzy meets the flea again, with bad consequences), and Henrietta Leavitt (whose work led to the discovery of the expanding universe and the Big Bang theory). In the course of endeavoring to solve the puzzle the cousins learn a lot of science: e.g., involving atoms and their formation, cells in the body, the universe, nuclear fusion, and the Big Bang.

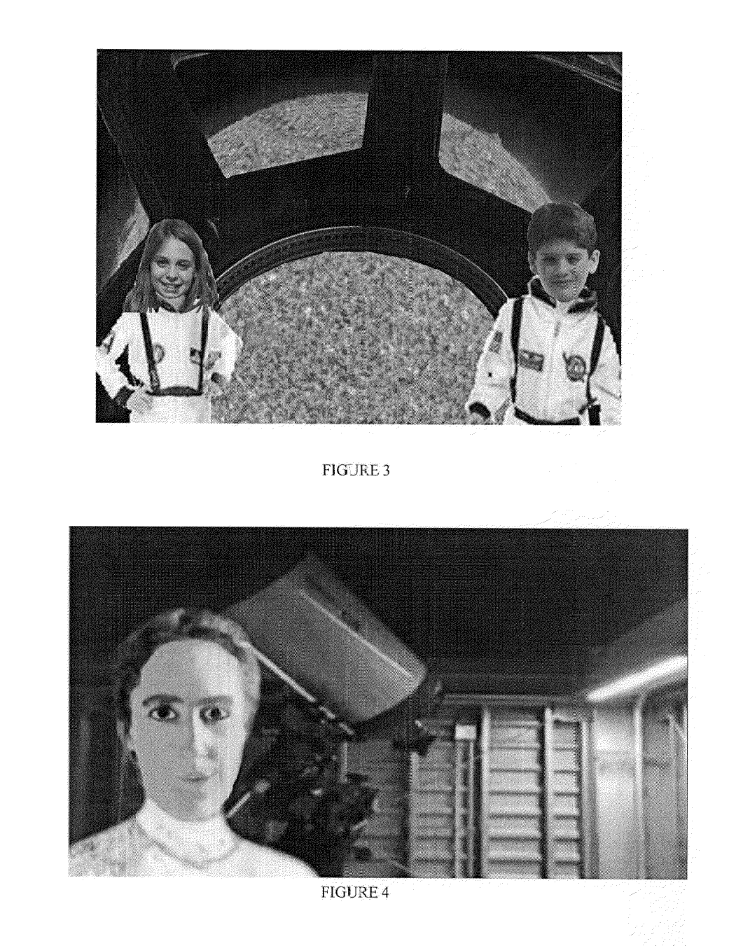

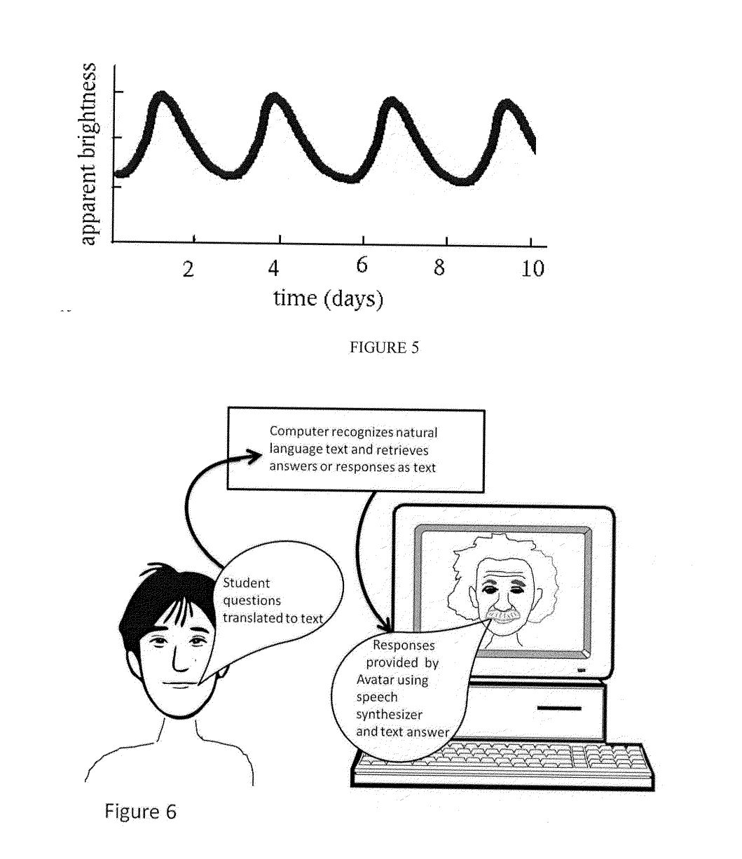

Further explanation of the concept is provided by text of THE STARDUST MYSTERY, as told by one of the book characters, Lizzy, as follows:
Anyway, after school, VC comes over to my house so she and I and Neddy could use the “Beamer” to visit Henrietta Leavitt as we'd promised at our team meeting. We logged on, entered her name and pressed GO. Her picture appeared, and the “Beamer” indicated that it was taking us to Harvard University in Cambridge Mass. in 1912. We took a screen shot of our arrival on the Harvard campus, to Show Milo. “Okay, now how do we find Henrietta,” I said. We wandered around until we found this bulletin board with announcements about stuff happening at Harvard. “We are so lucky,” said VC. “There is an announcement about a lecture by Henrietta Leavitt at the Harvard College Observatory. She is going to talk about her . . . ” and she read the title ‘Discovery of a Method to Measure the Distance to Stars’.
“Oh look,” said Neddy. “There's a lecture to follow by Edwin Hubble. Isn't he one of the people on the TSI list? And he's going to talk about ‘Some Observations Based on the Leavitt Method’. These things have got to be important to the STARDUST mystery.”
“So right,” I said and we all did high fives. Now we know where Henrietta worked so I asked someone “How do we get to the Harvard College ObservatoTy?” On the way there, we couldn't cross the street because there was a parade of women going by.
“What is going on?” asked VC of one of men in the crowd. “Oh,” said the man, “These women are Suffragettes. They are trying to get the right to vote for the president of the United States and for senators and congressmen. Isn't that ridiculous, women are much too emotional and are not educated enough to vote.”
“Wow,” said Neddy, “I'm sure glad that I didn't live back then. And those dresses are so ugly.”
We found Ms. Leavitt at her desk (see FIG. 4). “Hi,” said Neddy, “my name is Neddy, and this is Lizzy and VC. We are working on a science project and we heard that you made a fantastic discovery. Could you tell us about it?” “I am so happy that you girls are interested in science,” said Henrietta. I would be happy to help,” said Henrietta. “What would you like to know?”
“What did you discover” said Lizzy?” and why is it important?”
“Good questions,” said Henrietta. “Well, you know that this is the Harvard College Observatory and we look at stars and take their photographs using a telescope. The telescope makes things much bigger and sharper than what we can see with the naked eye. We ladies are called the ‘computers.’ What we do is identify each star and compute how bright it is in the photograph and write all the data in a big book.”
“That is funny, “I thought. “In those days a computer was a person, not an electronic device.”
Henrietta continued, “One problem that astronomers have is that if we see a very bright star, we don't know if it is bright because it is a very big star, or it is bright because it is a smaller star that is closer to earth. So, astronomers don't know how big the universe is. They don't know which stars are close and which are far away.”
“Ok,” said VC, “I understand that. How did you fix the problem?”
“Let's take a walk up to one of the telescopes,” said Henrietta. “It's easier if I show you what I did.” So we all climbed up on to the top floor of the building, to the biggest telescope. “This is where we take the star photographs” Ms. Leavitt pulled out some photos and said, “Here are some pictures that we took between Dec. 12, 1910 and Jan. 26, 1911. You see the star in the center. Look what happens to it during that time. In December, which are the top two photos, it seemed to get dimmer and then In January, it got very bright.
“I would measure how bright the star was every day and make a plot of brightness over time” said Henrietta. “Here is one of those plots for a star that changed from faint to bright over just two days (see FIG. 5). What I discovered from making these plots for lots of these ‘variable stars’ in a cluster was that for the brightest stars, it took longer to go from faint to bright. It seemed that the speed of change was a clue to how big the star was. Big stars took a month, while small stars took two days. If that was true, we had a way to determine how big a ‘variable star’ was. We just measure the time it takes it to go from bright to faint and that would tell us whether it was big or small. And for the first time since people started studying stars, we would know how big the ‘variable star’ is. My observation allows us to use its peak brightness to tell us how far away the star is. I think that could be very important for astronomy.”
“Thank you,” said Neddy. “You made it very easy to understand.”
“Can you help answer a question about our science project,” said Lizzy. “We think that our bodies are made of STARDUST and we think that the STARDUST is atoms. Could Atoms come from stars?”
“I don't know,” said Henrietta, “that is an interesting idea, but I don't have an answer. Maybe there will be some new discoveries, now that we can measure the distance to the stars. I know that Dr. Edwin Hubble has been using my method and he is going to talk about his observations later today. There is also a physicist in Belgium named Georges Lemaitre, who is also interested. He has written me to ask about my discovery. You will have to wait and see.”
“I have a question,” said Neddy. “Do you think that you will win a Nobel Prize for your discovery?
“Oh my, no” said Henrietta. “Thank you, but that will never happen. Only one woman, Marie Curie, has ever won a Nobel Prize in physics and I don't think that my work is that important.

As an example of a game that can be played in the virtual reality environment related to THE STARDUST MYSTERY book, the student must find the path to bring his component from the most elementary particle to the Stardust that was once in the body of George Washington and is now in their body. The student's component will change at each stage of the game from the starting point which is a quark created in the Big Bang and evolve through stages of proton, hydrogen atom, helium atom, and carbon atom. Then the student follows his carbon atom as it appears as part of: the earth, an amino acid, DNA, George Washington, the atmosphere, a carrot, and finally the student. The student must make choices of time, surround conditions, temperature, pressure, location, chemistry, and partners to combine with, to advance from one stage to the next. To help make the choices required to advance, the student may ask questions of Expert Avatars such as Albert Einstein, Henrietta Leavitt, J. Robert Oppenheimer, Georges Lemaitre, Johannes Kepler, Stephen Hawking and Edwin Hubble,

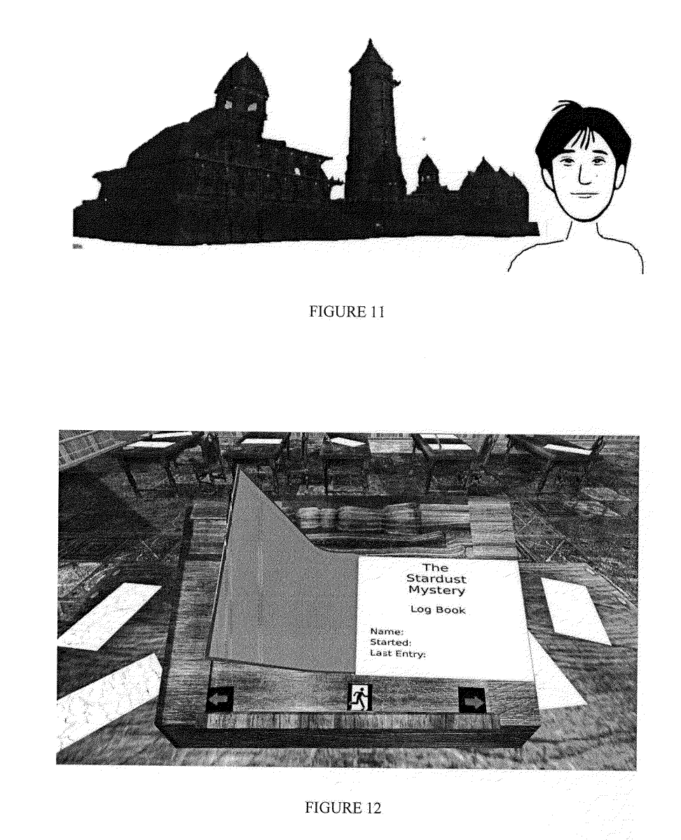

An alternative Stardust Mystery Game involves the student avatar in solving the same mystery that the book characters solve. The game could allow for the same time and space travel excursions made by the book characters. An environment and activities for such a game are illustrated in FIGS. 11 to 15. FIG. 12 illustrates a log book used in the game in which student's activities are preserved. The log book records the student's observations, answers to questions posed in the game, progress in space and time excursions and visits to Expert Avatars. The log data are used to score the student's achievements in the game and can be employed to test the student's knowledge of the subject being taught.

As another example of a game that can be played in the virtual reality environment related to THE EVOLUTION GAME book, the student avatar has a personal creature which starts out as a single cell. Players choose the conditions, resources, mutations, environment, predators, climate, reproduction, events, etc., to promote their creature's evolution in stages up to human. To gain information to make strategic game choices, players may ask questions of Expert Avatars like Charles Darwin, Mary Anning, Gregor Mendel, Jared Diamond, Neil Shubin, Carl Sagan, and do Early Earth Explorations to check on their creature and its environment at various stages. The stages of evolution are shown in FIG. 8.

One stage of the game is illustrated in FIG. 7. The concept (whose objectives and rules may be described in the book) illustrated for a candidate game stage shows the Student Avatar's creature is a rodent during the Jurassic period. The rodent can hide from the T-rex, but evolution to a larger mammal will be almost impossible with the presence of the large predators. The Student Avatar can choose on the right side panel between three Expert Avatars to ask questions for advice. The Expert Avatars will appear in some form. Dr. Louis Alvarez has the solution to the problem, which is to choose a meteor to hit the earth from the CHANGE CONDITIONS list at the top. Dinosaurs gone, problem solved and the Student Avatar moves to the next stage of evolution towards larger mammals.

A simple prototype of the Charles Darwin Expert Avatar has been implemented using a commercially available avatar creation and hosting site. FIG. 10 shows the Charles Darwin avatar, which responds verbally, using pre-scripted answers, to questions selected from the list in the figure. The facial expressions and lip movements are created by the commercially available software. To allow students to ask their own questions, a list of anticipated questions and answers for an AI database (Q&A Corpus) is generated for Charles Darwin, and the other Expert Avatars. Literature is searched and anticipated questions and answers are extracted. A 2009 Darwin exhibit in which actors instead of Expert Avatars gave answers had 199 Questions. Questions can be collected, for example, from students and teachers, from colleagues, from a chain email request, and Facebook requests. Questions for the Expert Avatars will address: their scientific contributions, student uncertainties, the Expert Avatar's life, and prior beliefs at that time. Answers are reviewed for accuracy, period authenticity, and tailored to the age of the audience to make the experience engaging, not frustrating.

As an example of AI technology, two AI software services are available: IBM's Watson available through IBM Bluemix and an AI systems employing the Artificial Intelligence Markup Language (AIML) available through Pandorabots. FIG. 16 illustrates how these may be combined. A patent by Scott Stevens et al. (U.S. Pat. No. 5,870,755 Method and Apparatus for Capturing and Presenting Digital Data in a Synthetic Interview, Scott M. Stevens and G. Christel, Feb. 9, 1999) describes an AI routine with similar features: a Q&A corpus is generated; semantic variations are added to both Q and A; the AI system compares the query to the corpus and assigns confidence values to the extent of match of words in the query to those in the questions, answers and semantic expansions of both; the confidence values are compared to thresholds, to determine whether to return the answer with the highest confidence value or a generic statement (e.g. you already asked that, can you rephrase the question, there may be more recent information, I don't know the answer, did you mean this or that); words in the corpus and query can be weighted to indicate their importance or unimportance.

Thus, it can be seen from the foregoing description that the present invention provides a novel, effective, and engaging educational system for teaching science, history, and other subjects to pupils in kindergarten through high school grades, and beyond, with little or no teacher involvement required.

Having thus described the invention, what is claimed is:

1. An educational system for learning about science, history and other subjects comprising:
a book whose fictional characters are exposed to factual science, history or other subjects by using a fictional virtual reality environment to visit important people, places and events associated with these topics at any time, and in which visits to important people involve a conversation in which the characters ask questions of the important people and receive factual answers;
a combination of software components capable of creating a computer-based virtual reality environment that can duplicate for the reader, the visits in the book's fictional virtual reality environment to important people, places and events at any time, said software components including at least: (a) 3D virtual reality environment software that supports moving and speaking avatars; (b) artificial intelligence software with specific and general data bases that provides answers by Expert Avatars to user's questions; (c) text-to-speech software to provide verbal delivery of Expert Avatar text answers; and (d) logging software to record the user's activities, said software combination allowing the reader to choose and affect the activities of the virtual reality environment, and with which the reader can have a conversation in which he or she can ask questions of the important people, represented as Expert Avatars included in the computer-based virtual reality environment, and receive factual answers delivered by the Expert Avatar;
electronic data processing means employing the software to create the visual and auditory components of the virtual reality environment including responses of the Expert Avatars.
a digital device having at least: (a) a display screen, (b) speakers or headphones, (c) a microphone, and (d), as an input device, a keyboard, touch screen and/or mouse, on which the visual and auditory components of the virtual reality environment may be displayed and heard by the device user and in which the reader can affect the activities in the virtual reality environment through use of an input device.

2. The system of claim 1 wherein the book is printed or in electronic form.

3. The system of claim 1 wherein the software combination also includes at least one of game software, speech recognition software, and testing software.

4. The system of claim 1 wherein the software is constructed to allow the reader to appear in the virtual reality environment as an avatar.

5. The system of claim 1 wherein the artificial intelligence software includes multiple programs and data bases in a hybrid system.

6. The system of claim 1 wherein the electronic data processing means is comprised of a plurality of components, wherein the separate components reside in plural locations and are digitally connected through at least one of wire, Wi-Fi, internet, intranet and other connection means.

7. The system of claim 1 in which the digital device is selected from a computer, smartphone, tablet, television set, watch, or video game hardware.

8. The system of claim 1 in which the computer-based virtual reality environment is constructed to be employed by a single or plurality of users simultaneously.

9. The system of claim 5 in which the hybrid artificial intelligence system consists of a first software layer designed to support a chat, using a data base of anticipated questions and answers for a specific Expert Avatar, and a second software layer to answer questions not answered by the first layer supported by a general encyclopedia data base.

10. The system of claim 5 in which the hybrid artificial intelligence system consists of a first software layer designed to support a search and matching routine using both a data base of anticipated questions and answers for a specific Expert Avatar and a general encyclopedia data base, in which answers are provided with confidence values, and a second software layer which selects answers to be delivered by the Expert Avatar based on the confidence values.
